(19) United States
(12) Patent Application Publication
(10) Pub. No.: US 2020/0245818 A1
(43) Pub. Date: Aug. 6, 2020

(54) COMPONENT STORAGE AND MIXING DEVICES, SYSTEMS, AND METHODS

(71) Applicants: Michael John Halkes, Central (HK); Andrew Patrick McCarthy, North Point (HK)

(72) Inventors: Michael John Halkes, Central (HK); Andrew Patrick McCarthy, North Point (HK)

(21) Appl. No.: 16/781,581

(22) Filed: Feb. 4, 2020

Related U.S. Application Data
(60) Provisional application No. 62/801,301, filed on Feb. 5, 2019.

(51) Int. Cl. A47J 43/27; B01F 13/00; B65D 85/72; B65D 51/28; B65D 43/02

(52) U.S. Cl. CPC A47J 43/27; B01F 13/0022; B65D 53/02; B65D 51/28; B65D 43/0225; B65D 85/72

(57) ABSTRACT

Container devices, systems, and methods are provided. In some embodiments, an example container includes a first vessel, a second vessel, a cap, and a seal. In a first configuration, the second vessel may be suspended from the cap within the first vessel and the first and second vessels are each in sealing engagement with the seal. In a second configuration, the second vessel is separated from the cap and released into the first vessel.

### PRIORITY CLAIM

This application claims priority under 35 USC § 119(e) to U.S. Provisional Patent Application Ser. No. 62/801,301, filed on Feb. 5, 2019, the entire contents of which are hereby incorporated by reference.

### TECHNICAL FIELD

This disclosure describes devices, systems, and methods related to storage and mixing, for example beverage component storage and mixing.

### BACKGROUND

Liquid containers are commonly used to store and/or mix liquids. For example, some containers have been used to store a quantity of two components. The components may be stored independently and mixed at a time of use.

### SUMMARY

Some embodiments described herein include component storage and mixing devices, systems, and methods. For example, a component storage and mixing device may include multiple vessels that can independently store multiple components (e.g. out of fluid communication with one another) until a time of use. The component storage and mixing device may optionally be configured so that the components may be brought into communication with one another by manual activation, such as by causing a relatively smaller vessel to drop or fall into a relatively larger vessel.

Some optional storage and mixing devices described herein may be configured as a beverage container. For example, the container may include first and second vessels that include first and second cavities configured to store first and second beverage components out of communication with one another. The first and second components may be mixed (e.g. by a user intending to consume the beverage) at a time of consumption. The device may be configured to enhance the user experience by simulating dropping a shot glass into a beverage component, for example. In various optional embodiments, storage and mixing devices may be configured to store components of chemical products, multi-part epoxies, industrial or consumer products, healthcare products, etc.

Some optional embodiments described herein include first and second vessels that are sealed (e.g. from fluid communication with one another and/or the external environment) by a common sealing device. For example, the first and second vessels may include sealing surfaces that engage or interact with a common sealing surface of the sealing device. Alternatively or additionally, some optional embodiments described herein include a first vessel that defines a first opening and a second vessel that defines a second opening. When in a sealed configuration, the first and second openings of the first and second vessels are aligned, and when in a released configuration (e.g. when the second vessel has been released such that the contents of the first and second vessels may interact) the first and second openings of the first and second vessels are not aligned.

Some optional embodiments described herein may include a base component contained within the first vessel and an additive component within the second vessel. For example, some optional embodiments described herein may include a base beverage component contained within the first vessel and an additive beverage component (e.g. such as a beverage component sometimes referred to as a “shot” component) within the second vessel. The second vessel is releasable into the first vessel, so that the “shot” beverage component may be brought into communication with the base beverage component. In some optional embodiments, the second vessel is releasable by removal of a cap, such that additional manipulation beyond opening the device is not required in order to release the second vessel and bring the beverage components into communication with one another.

Particular example embodiments described herein include a beverage container, comprising a first vessel having a first cavity configured to contain a first fluid, and a top region that defines a first outlet, the top region including an outer surface having engagement threads; a second vessel configured to be retained within the first vessel by an interference along an outer surface of the second vessel, the second vessel having a second cavity configured to contain a second fluid out of fluid communication with the first fluid, and a top region that defines a second outlet; a threaded cap having an annular channel; and a seal located in the annular channel of the threaded cap. In a first configuration the top region of the first vessel and the top region of the second vessel are each in sealing engagement with the seal, and in a second configuration the second vessel is completely separated from the cap, and axial removal of the threaded cap causes the second vessel to be released from the first configuration to the second configuration.

In some implementations, the container can optionally include one or more of the following features. The threaded cap and the second vessel may be separately formed components. In the first configuration the second vessel may be suspended within the first vessel at least partially supported by an interference fit with the threaded cap. The second vessel may be at least partially sealed by engagement with the seal within the cap. The cap may include an annular protrusion, and when in the first configuration the annular protrusion may be located at least partially within the first vessel and the second vessel. The cap may include a circumferential recess along an outer circumference of the annular protrusion, and the second vessel may include a plurality of protrusions along an inner surface of the second vessel, the plurality of protrusions configured to be received by the recess. The plurality of protrusions may include three protrusions spaced along the inner surface of the second vessel. The annular seal may be made of a first material and the cap may be made of a second material, and the first material may be softer than the second material. The cap may be made of a first material and the first vessel may be made of a second material, and the first material may be softer than the second material. The first vessel may be made of a first material and the second vessel may be made of a second material, and the first material may be softer than the second material. In the first configuration the first vessel may optionally contain a non-alcoholic liquid and the second vessel may optionally contain an alcoholic liquid.

Particular embodiments described herein include a container comprising a first vessel including a first cavity, and a top region that defines an opening and includes first threads along an outer surface of the first vessel; and a cap including a first annular protrusion extending towards an interior of the first cavity when the cap is installed on the first vessel, a second annular protrusion extending parallel with the first annular protrusion, the second annular protrusion having second threads along an inner surface of the second annular protrusion, the second threads configured to engage with the first set of threads; and a second vessel configured to be accommodated within the first vessel, the second vessel including an attachment means configured to secure the second vessel to the cap, and a retention means configured to retain the second vessel within the first vessel when the cap is removed from the first vessel; and an annular seal located within the circular cap, the annular seal located between a first annular protrusion of the cap and a second annular protrusion of the cap; wherein in a first configuration, the first vessel and the second vessel are each in direct sealing engagement with the annular seal.

In some implementations, the container can optionally include on or more of the following features. The annular seal may be made of a first material and the cap may be made of a second material, and the first material may be softer than the second material. The cap may be made of a first material and the first vessel may be made of a second material, and the first material may be softer than the second material. The first vessel may be made of a first material and the second vessel may be made of a second material, and the first material may be softer than the second material. The cap may include a circumferential recess along an outer circumference of the first annular protrusion, and the second vessel may include a plurality of protrusions along an inner surface of the second vessel, the plurality of protrusions configured to be received by the circumferential recess. The plurality of protrusions may include three protrusions equally spaced along the inner surface. In the first configuration the first vessel may contains a non-alcoholic liquid and the second vessel may contains an alcoholic liquid.

Particular embodiments described herein include a method of storing and mixing beverage components comprising: storing a first beverage component within a first vessel, the first vessel sealingly engaged with a seal of a cap; and storing a second beverage component in a second vessel out of fluid communication with the first vessel, wherein the second vessel is located within the first vessel and sealingly engaged with the seal of the cap.

In some implementations, the system can optionally include one or more of the following features. The second beverage component may include alcohol. The first vessel may contains a non-alcoholic liquid and the second vessel may contain an alcoholic liquid. The method may further comprise releasing the second vessel into the first vessel when the cap is removed from the first vessel.

The devices, systems, and techniques described herein may provide one or more of the following advantages. First, various embodiments described herein may provide an easy-to-use system for storing components and facilitating mixing by a user at a time of use. Components may be stored independently, which can reduce degradation over time or due to exposure to one another or the external environment, and can be brought into communication at a time of use

Second, some embodiments described herein facilitate sealing multiple vessels via a single sealing component. For example, first and second vessels may be in sealing engagement with a common sealing component when in a sealed configuration (e.g. such that the device includes only a single sealing component).

Third, various containers described herein can enhance the user experience in mixing and consuming beverages, such as by simulating a shot glass dropping into a beverage. For example, a second vessel may be releasable into the first vessel such that the second vessel drops (e.g. from a cap) and falls into a liquid within the first vessel. Release of the second vessel such that transition from a sealed configuration to a released configuration may be perceived to simulate manually dropping a shot glass into a beverage.

Fourth, some embodiments described herein may facilitate efficient, reliable, and repeatable manufacturing and assembly. For example, some embodiments may include relatively few components (e.g. four or fewer components of a first vessel, a second vessel, seal, and a cap) while providing first and second volumes that may contain first and second components out of fluid communication with one another. Some containers may seal multiple vessels using a single sealing component, reducing the need for additional sealing components and/or complex assembly operations. Alternatively or additionally, the geometry of various components may promote efficient manufacturing. For example, a second vessel may include engagement features including an odd-number or asymmetric arrangement of protrusions or features than can facilitate efficient molding and release from a mold.

Fifth, some embodiments described herein may facilitate independent storage of components, such as beverage components, that may otherwise have a reduced shelf life or reduced appeal to a consumer if stored in a mixed state. For example, some embodiments described herein include a first vessel containing a non-alcoholic liquid or a liquid having a relatively lower alcohol content, and a second vessel containing an alcoholic liquid or a liquid having a relatively higher alcohol content as compared to the liquid within the first vessel. The container may thus provide storage of liquids having different characteristics, such as a different visual appearance, aroma, flavor, alcohol content, nutritional requirement, or storage requirements. Alternatively or additionally, some embodiments described herein facilitate storage of an alcohol-containing liquid independent of a component that may degrade or have a reduced shelf life upon exposure to the alcohol-containing liquid.

Sixth, some embodiments described herein facilitate consumption of a multi-component beverage in a partially mixed state. For example, some embodiments facilitate release of a second vessel into the first vessel as a cap is removed to open the first vessel. First and second liquids can be consumed before substantially mixing, such that the appearance, flavor, aroma, and/or other characteristics of the first and second liquids are independently perceptible while the beverage is consumed.

The details of one or more embodiments of the subject matter described in this disclosure are set forth in the accompanying drawings and the description below. Other features, aspects, and advantages of the subject matter will be apparent from the description, the drawings, and the claims.

### BRIEF DESCRIPTION OF THE DRAWINGS

FIG. 1A is an exploded perspective view of an example storage and mixing device.

FIG. 1B is a cross-sectional view of an example storage and mixing device in a sealed configuration.

FIG. 1C is a cross-sectional view of an example storage and mixing device in a released state.

FIG. 2 is a perspective view of an example cap and seal of the storage and mixing device shown in FIGS. 1A-1C.

FIG. 3 is an example inner vessel of the storage and mixing device shown in FIGS. 1A-1C.

FIG. 4 is a partial cross-sectional view of the storage and mixing device shown in FIGS. 1A-1C

FIG. 5 is a flow diagram of an example method of making a storage and mixing container.

FIG. 6 is a flow diagram of an example method of mixing first and second components.

### DETAILED DESCRIPTION OF ILLUSTRATIVE EMBODIMENTS

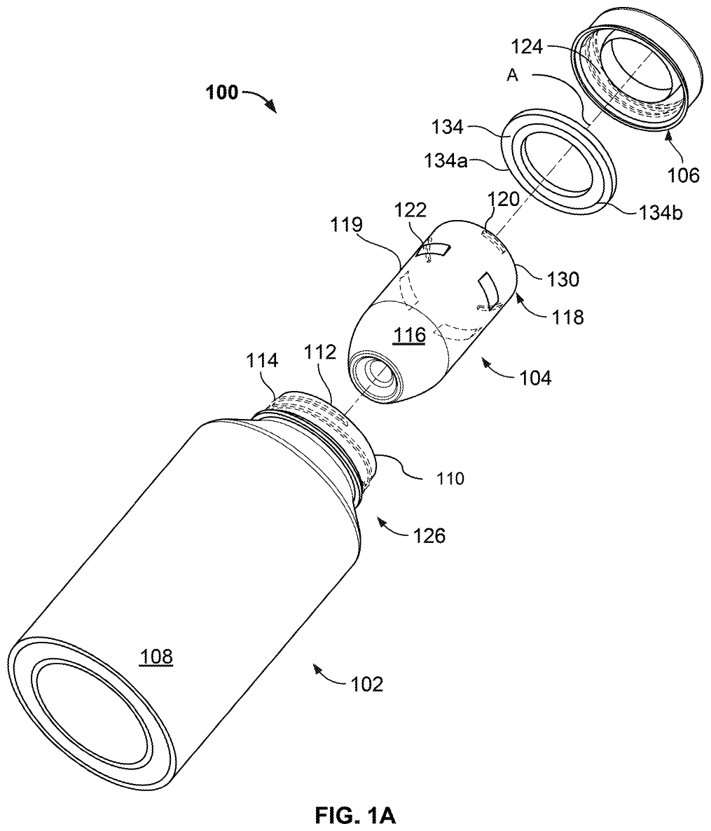

Referring to FIGS. 1A-1C, an example container 100 is shown that includes a first vessel 102, a second vessel 104, and a cap 106. The first vessel 102 includes a first cavity 108 that defines a first volume. The second vessel 104 includes a second cavity 116 that defines a second volume. The first and second vessels 102, 104 may be sealed (e.g. by cap 106) such that first and second components, such as first and second liquid components of a beverage, may be stored out of communication with each other. At a time of use, the contents of the first and second cavities 108, 116 may be brought into communication and mixed.

The first vessel 102 includes a first opening 112 (FIG. 1B). Contents of the first cavity 108 may pass through the first opening 112 when the first cavity 108 is filled and/or when contents are dispensed from the first cavity 108. In an example embodiment, the first vessel 102 includes a top region 110 and a body portion 111, and the top region 110 may define the opening 112.

The second vessel 104 includes a second opening 130. Contents of second cavity 116 may pass through second opening 130 when second cavity 116 is filled and/or when contents are dispensed from second cavity 116 (e.g. dispensed from second cavity 116 into first cavity 108). In an example embodiment, the second vessel includes a top region 118 and a body portion 119, and the top region 118 may define the second opening 130.

In an exemplary embodiment, the first opening 112 of the first vessel 102 may have a diameter greater than or equal to the second opening 130 of the second vessel 104. Alternatively or additionally, the first opening 112 of the first vessel 102 may have a diameter equal to or less than a diameter of the body portion 119 of the first vessel 102. The first opening 112 may thus have a size that is equal to or smaller than a diameter of the body portion 119 of the first vessel 102.

In various exemplary embodiments, the first opening 112 of the first vessel 102 may have a cross-sectional area greater than or equal to a cross-sectional area of the second opening 130 of the second vessel 104. Alternatively or additionally, the first opening 112 of the first vessel 102 may have a cross-sectional area equal to or less than a diameter of the body portion 119 (e.g. the greatest diameter of the body portion 119) of the first vessel 102. For example, first vessel 102 may have a uniform (e.g. completely uniform, or substantially uniform with about 10%) cross-sectional area such that the first vessel 102 has an appearance of a consistent diameter. Alternatively, first vessel may have a dimeter that varies such that the first vessel 102 has a contoured or tapered appearance.

In various exemplary embodiments, first opening 112 has a diameter or cross-sectional area that is between 50% and 95%, 60% and 80%, or about 75% of a diameter or cross-sectional area of body portion 119 of first vessel 102. Alternatively or additionally, second opening 130 of second vessel 104 has a diameter or cross-sectional area that is between 75% and 99%, 80% and 95%, or about 90% of a diameter or cross-sectional area of first opening 112 of first vessel 102. In some example embodiments, second opening 130 of second vessel 104 has a diameter or cross-sectional area that is between 95% and 99% of a diameter or cross-sectional area of first opening 112 of first vessel 102. Such relative dimensions may provide first and second openings 112, 130 that facilitate efficient filling, mixing, and/or dispensing, while promoting a streamlined and attractive visual appearance of container 100.

First vessel 102 may include one or more engagement features configured for releasable engagement with cap 106. In some embodiments, the one or more engagement features include first threads 114 located along an outer surface of the first vessel 102. Alternatively or additionally, threads 114 may be located on an inner surface of the first vessel 102. The first threads 114 may interact with complementary threads or other engagement features of the cap 106, such as threads 124. In some embodiments, the threads 114 are located at or near the top region 110, at least partially around a perimeter of the opening 112. Interaction between threads 114 of first vessel 102 and threads 124 of cap 106 facilitate engagement by relative rotation and movement along longitudinal axis A between first vessel 102 and cap 106. In various embodiments, the one or more engagement features may include a clasp, latch, snap-fit, etc., that facilitate engagement between the first vessel 102 and the cap 106.

The second vessel 104 is configured to be at least partially accommodated within the first vessel 102. For example, the second vessel 104 includes a second cavity 116 configured to store a component out of fluid communication with the first cavity 108 of first vessel 102 while the second vessel 104 is at least partially accommodated within the first vessel 102. In an example embodiment, second vessel 104 includes a top region 118 that defines the opening 130, and one or more attachment features 120 that facilitate releasable engagement with the cap 106. In a sealed configuration (FIG. 1B), the attachment features 120 may be engaged with a complementary feature of cap 106, and in a released configuration (FIG. 1C) the second vessel 104 including attachment features 120 is not in contact with the cap 106.

Attachment features 120 of second vessel 104 may engage with one or more complementary features of cap 106, such as an annular recess 204 of flange 202. The annular protrusion 202 (FIG. 1C) may extend from a major surface of cap 106 (e.g. parallel to longitudinal axis A). The protrusion 202 may include one or more features that facilitate secure engagement with attachment features 120, such as a rib, protrusion, channel, varying wall thickness, etc. In an exemplary embodiment, the protrusion 202 may have an arcuate outer surface 202a that promotes an interference fit with the attachment features 120.

Attachment features 120 may be configured to facilitate secure engagement with the cap 106 while promoting efficient manufacturing. In an exemplary embodiment, the attachment features 120 include an odd number of protrusions (e.g. three protrusions) spaced around an interior surface of the second vessel 104. In some embodiments, the attachment features 120 may thus be described as positioned asymmetrically about the central, longitudinal axis A.

The second vessel 104 may include a retention feature 122 configured to retain the second vessel 104 within the first vessel 102. For example, retention feature 122 may be configured to allow the second vessel 104 to be inserted into the first vessel 102, and to resist or limit removal of the second vessel 104 from the first vessel 102. When the second vessel 104 is accommodated within the first vessel, retention feature 122 may resist or limit movement of the second vessel 104 along longitudinal axis A relative to first vessel 102 such that the second vessel 104 is prevented from passing through first opening 112. In some embodiments, the retention feature 122 thus facilitates separation of the second vessel 104 from the cap 106 when the cap 106 is unscrewed or otherwise removed from engagement with the first vessel 102.

In an example embodiment, the first vessel 102, the second vessel 104, and the cap 106 are separate and distinct components from one another. For example, each of the first vessel 102, the second vessel 104, and the cap 106 may be separately molded or manufactured (e.g. each as an independent, unitary component). The first vessel 102, the second vessel 104, and the cap 106 may subsequently be assembled into the sealed configuration after components are loaded into the first and second cavities 108, 116. In such embodiments, the cap 106 may be removed, and the second vessel 104 may be released into the first vessel 102, without shearing or breaking of any components (e.g. no shearing or breaking of components is necessary for the cap 106 and the second vessel 104 to separate) Such a configuration can promote efficient manufacturing, filling, and sealing of container 100, and/or provide an enhanced user experience.

Referring now to FIG. 1B, a cross-sectional view of an assembled container 100 is shown. In an example embodiment, the first cavity 108 within the first vessel 102 contains a first fluid 127, and the second cavity 116 within the second vessel 104 contains a second fluid 128. The container 100 is in a sealed configuration in which the first cavity 108 is sealed from fluid communication with the second cavity 116, and the first and second cavities 108, 116 are sealed from fluid communication with the external environment.

In an example sealed configuration, the second vessel 104 is retained within the first vessel 102 at least partially suspended above the first fluid 127. The second vessel 104 may be retained within the first vessel 102 by an interference between an inner surface of the second vessel 104 and the cap 106, and/or an outer surface of the second vessel 104 and an inner surface of the first vessel 102. In an example embodiment, the second vessel 104 is at least partially supported by the threaded cap 106, for example, with an interference fit such that frictional engagement between the second vessel 104 and the cap 106 maintains the second vessel 104 in the sealed configuration.

In an example embodiment, the second vessel 104 is configured to be accommodated by the first vessel 102 in the sealed configuration so that the first opening 112 and the second opening 130 are substantially in-line with one another (e.g. such that the first opening 112 and the second opening 130 are co-planar). For example, both the first opening 112 and the second opening 130 may face in a same direction, such as upwardly facing, when in the sealed configuration. Alternatively or additionally, the first opening 112 and the second opening 130 may be aligned about a common, central longitudinal axis, such as longitudinal axis A, such that the longitudinal axis A passes through the center of first opening 112 and the center of second opening 130.

The first vessel 102 may have a height (H) and the second vessel 104 may have a height (h) measured in a direction parallel to central longitudinal axis A. The relative heights of the first and second vessels 102, 104, may be selected to define particular volumes within the first and second vessels 102, 104, and/or to enhance the visual effect when in a sealed configuration and/or when the second vessel 104 is released. In various exemplary embodiments, height (h) of second vessel 104 is greater than 20%, greater than 30%, greater than 40% greater than 50%, or greater than 60% of height (H) of first vessel 102. In some embodiments, height (h) of second vessel 104 may be between 25% and 75%, 40% and 60%, or about 50% of height (H) of first vessel 102.

The retention feature 122 of the second vessel 104 may extend outwardly from the outer surface of the first vessel 102. For example, when in a sealed configuration, the retention feature 122 is located below a shoulder 135 of the first vessel 102, or otherwise located to interact with shoulder 135 and/or another feature of the first vessel 102. The retention feature 122 may interfere with the shoulder 135 or other feature of the first vessel 102 to prevent movement of second vessel 104 through first opening 112 of first vessel 102 (e.g. when the cap 106 is removed). The interference caused by the retention feature 122 thus may facilitate retention of the second vessel 104 within the first vessel 102, and facilitates release of the second vessel 104 from the cap 106 and the first vessel 102 when the cap 106 is removed, for example.

In an example embodiment, the retention feature 122 only interacts with the shoulder 135 and/or another feature of the first vessel 102 when the cap 106 is removed (e.g., the retention feature 122 is not in contact with the first vessel 102 before the cap is removed). During removal of cap 106, the retention feature 122 (and second vessel 104) may thus move upward slightly before interference between retention feature 122 and first vessel 102 results in release of the second vessel 104 from the cap 106.

The first and second vessels 102, 104 may be sized to accommodate desired quantities of materials, and to allow release of the second vessel 104 into the first vessel (e.g. such that the first liquid 127 will not over-flow the first vessel 102 when the second vessel 104 is released). For example, the second vessel 104 is configured to hold a quantity of a second beverage component 128 to mix a desired beverage with a desired ratio compared with the first beverage component 127. In various exemplary embodiments, a volume of first cavity 108 may be between 2 and 12, 3 and 8, or about 6 times the volume of second cavity 116. In various exemplary embodiments, container 100 may include a volume of first fluid 127 within first cavity 108 that is between 1 and 10, 2 and 8, or about 4 times a volume of second fluid 128 within second cavity 116.

In some embodiments, the second vessel 104 is configured to be suspended entirely above a first fluid 127 within first cavity 108 when in the sealed configuration, or a fill-line of the first vessel 102, such that a bottom of second vessel 104 is separated from first fluid 127 by a gap or space. In other embodiments, the second vessel 104 may extend slightly below the fill line and/or may be partially submerged within first fluid 127.

The cap 106 may be configured to at least partially accommodate the seal 134. In some embodiments, the cap 106 includes an annular channel 132 (FIG. 1C) in which the seal 134 may be located, such as a channel 132 defined between an outer wall 125 and annular projection 202. The channel 132 may have a width and depth sufficient to accommodate the seal 134 and portions of first vessel 102 and second vessel 104, such as a portion of the top region 126 of the first vessel 102 and the top region 118 of the second vessel 104. For example, both the first vessel 102 and the second vessel 104 can be located partially within channel 132 in sealing engagement with the seal 134, and simultaneously engaged with the cap 106. The seal 134 may seal both the first vessel 102 and the second vessel 104 from communication with an outside environment, and with one another. Such isolation can reduce contamination, oxidation, or other degradation of components within the first vessel 102 or the second vessel 104. In some embodiments, the seal 134 can fluidically isolate a first component 127 housed within the first vessel 102 and a second component 128 within the second vessel 104 from one another.

The seal 134 may be made from a relatively softer or deformable material that promotes consistent sealing engagement with first and second vessels 102, 104. For example, a surface of the first vessel 102 and/or a surface of the second vessel 104 (e.g. surfaces that define the openings 112, 130) may abut the seal 134 with sufficient force to partially deform the seal 134. The deformation may improve the effectiveness and or consistency of the sealing engagement. The resiliency of the seal 134 may result in a restoring force that acts to restore the seal 134 to an undeformed configuration which in turn promotes consistent contact with first and/or second vessels 102, 104. In an example embodiment, the seal 134 that contacts both the first vessel 102 and the second vessel 104 is a single, continuous component. The seal 134 may include one or more flanges, ribs, contours, etc. that promote sealing with the first vessel 102, the second vessel 104, and the cap 106. For example, the seal 134 may include an outer flange 134a and/or a rib 134b. The rib 134b may be positioned between the first vessel 102 and the second vessel 104 when the cap 106 is attached with the first vessel 102 and the second vessel 104.

Referring now to FIG. 1C, cross-sectional view of the beverage container 100 is shown in the released configuration after the cap 106 has been removed. The axial movement of the cap 106 along longitudinal axis A for first and second vessels 102, 104, results in the second vessel 104 being released from the configuration shown in FIG. 1B in which the top region 126 of the first vessel 102 and the top region 118 of the second vessel 104 are each in sealing engagement with the seal 134. The release causes the beverage container 100 to move to a second configuration illustrated in FIG. 1C. In the released configuration, the second vessel 104 is completely separated from the cap 106. In some embodiments, the second vessel 104 is additionally separated from the first vessel 102, such that the second vessel 104 is accommodated freely within the first cavity 108 and out of frictional engagement or interference with first vessel 102. For example, when in the released configuration, the first and second components 127, 128 may be consumed or otherwise dispensed through opening 112 without second vessel 104 substantially blocking the flow of first and second components 127, 128 (e.g. in an at least partially mixed state) even though the second vessel 104 may be loose and freely movable within the first vessel 102. Alternatively or additionally, the second vessel cannot readily pass through the opening 112 (e.g. without permanently damaging the first vessel 102 and/or the second vessel 104) even though the second vessel 104 may be loose and freely movable within the first vessel 102.

The second vessel 104 may be configured to be slidably separated from the cap 106 when the cap 106 is removed. For example, as the cap 106 is moved axially to remove the cap 106, the second vessel 104 may slide along annular protrusion until the cap 106 and second vessel 104 are separated. In an exemplary embodiment, once the cap 106 and second vessel 104 are separated, the second vessel 104 may freely drop into the first vessel with the aid of gravity. The first fluid 127 may thus mix with the second fluid 128. In an exemplary embodiment, only the cap 106 covers opening 130 of second vessel 104 such that there is no film, foil, or other additional covering over opening 130 that must be ruptured or removed from second vessel 104 in order to allow the contents of second vessel. The release of second vessel 104 may be perceived as simulating a “drop” of a shot glass into a container that may be characteristic of various beverages.

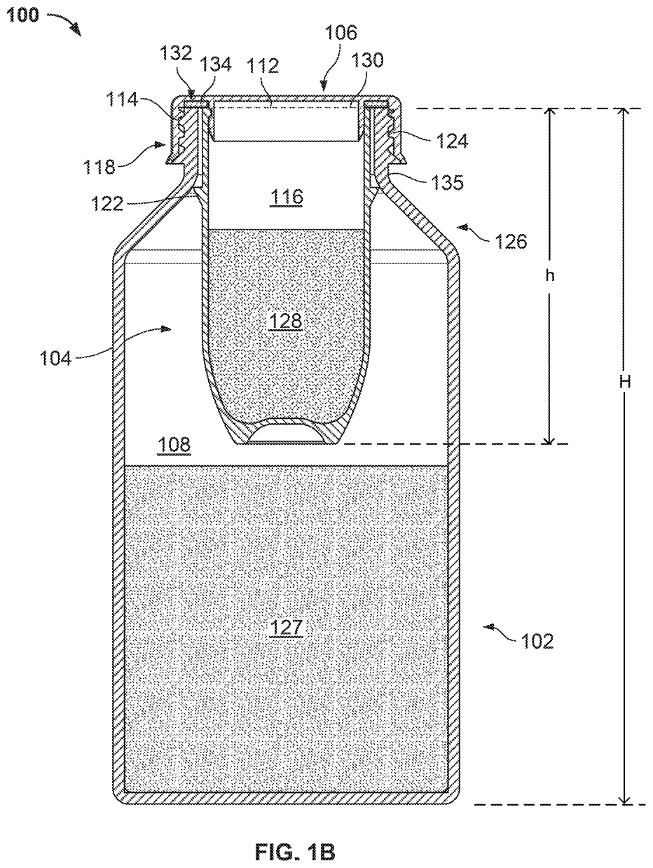

FIG. 2 is a perspective view of an example cap 106. In various embodiments, cap 106 may be used with containers including one or more features described herein such as container 100 described with reference to FIGS. 1A-1C. The cap 106 includes a first annular protrusion 202 that is configured to be inserted into both a first vessel, such as first vessel 102 (FIGS. 1A-1C) and a second vessel, such as second vessel 104 (FIGS. 1A-1C). That is, the annular protrusion 202 may extends towards an interior of both the first vessel 102 and the second vessel 104 when the cap 106 is installed on the first vessel 102, and/or may be located closer to a central, longitudinal axis of a container than adjacent portions of first and second vessels. Annular protrusion 202 may include one or more engagement features configured to engage with a vessel, such as an arcuate shape and/or a circumferential recess 204 along an outer circumference. The circumferential recess 204 may be configured to interact with a complementary feature of a vessel to facilitate secure engagement between the cap 106 and vessel.

Alternatively or additionally, the cap 106 may include a second annular protrusion 206 that extends parallel (e.g. in substantially the same direction) with the first annular protrusion 202. In an exemplary embodiment, the second annular protrusion 206 may form an outer wall of the cap 106. The second annular protrusion 206 may include one or more engagement features for engaging a vessel, such as threads 124 along an inner surface of the second annular protrusion 206. The threads 124 may configured to engage with the complementary threads of a vessel, such as threads 114 of vessel 102 (FIGS. 1A-1C). Alternatively or additionally, the cap 106 may include other engagement features, such as a clasp, latch, snap-fit, etc.

The cap 106 may be configured to accommodate a seal 134 such that the seal 134 may be in simultaneous sealing engagement with both first and second vessels. For example, the cap 106 may define a channel or annular space that the seal 134 may be located within. In an exemplary embodiment, the seal 34 is a separately formed component that is installed or attached to cap 106. Alternatively or additionally, seal 134 may be integrally formed with cap 136 as a unitary component, and may provide a surface of the cap 106 that one more vessels may sealingly engage with.

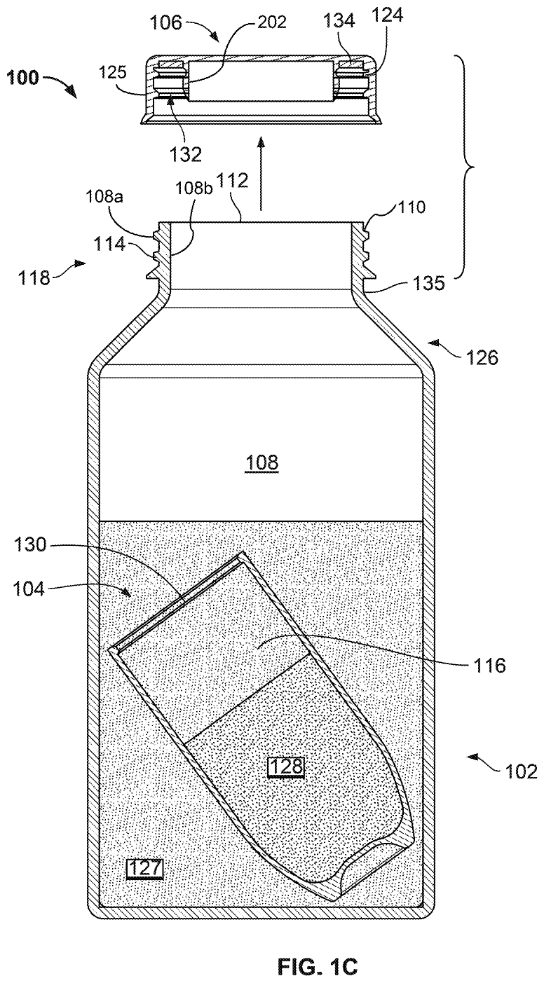

Referring now to FIG. 3, a perspective view of an example second vessel 104 is shown. In various example embodiments, second vessel 104 may be used with containers including one or more features described herein, such as container 100 described with reference to FIGS. 1A-1C, and/or cap 106 described with reference to FIG. 2.

The second vessel 104 includes multiple protrusions 120 along top region 118, such as along a perimeter that defines opening 130. The protrusions 120 may be configured as attachment features that facilitate engagement with a cap, such as cap 106. When in a sealed configuration with a cap, the attachment features 120 may be engaged with a complementary feature of the cap 106. Attachment features 120 of second vessel 104 may engage with one or more complementary features of the cap, such as an annular protrusion or flange. Attachment features 120 may be configured to facilitate secure engagement with cap 106 while promoting efficient manufacturing. In an exemplary embodiment, attachment features 120 include an odd number of protrusions (e.g. three protrusions) spaced around an interior surface of second vessel 104. In some embodiments, attachment features 120 may thus be described as positioned asymmetrically about the central, longitudinal axis A. Such configurations may promote secure engagement in use, while facilitating manufacturing.

Second vessel 104 may include one or more retention features 122 configured to retain the second vessel 104 within a first vessel, such as first vessel 102. For example, retention feature 122 may be configured to allow the second vessel 104 to be inserted into a first vessel, and to resist or limit removal of second vessel 104 from the first vessel. When the second vessel 104 is accommodated within the first vessel, retention feature 122 may resist or limit movement of second vessel 104 along a longitudinal axis A relative to the first vessel. For example, retention features may be configured as tabs, barbs, ramps, etc. having an angled or ramped surface that allows unidirectional movement of the second vessel 104 relative to a feature of a first vessel that the second vessel 104 may be accommodated within. In some embodiments, retention feature 122 thus facilitates separation of second vessel 104 from a cap or first vessel.

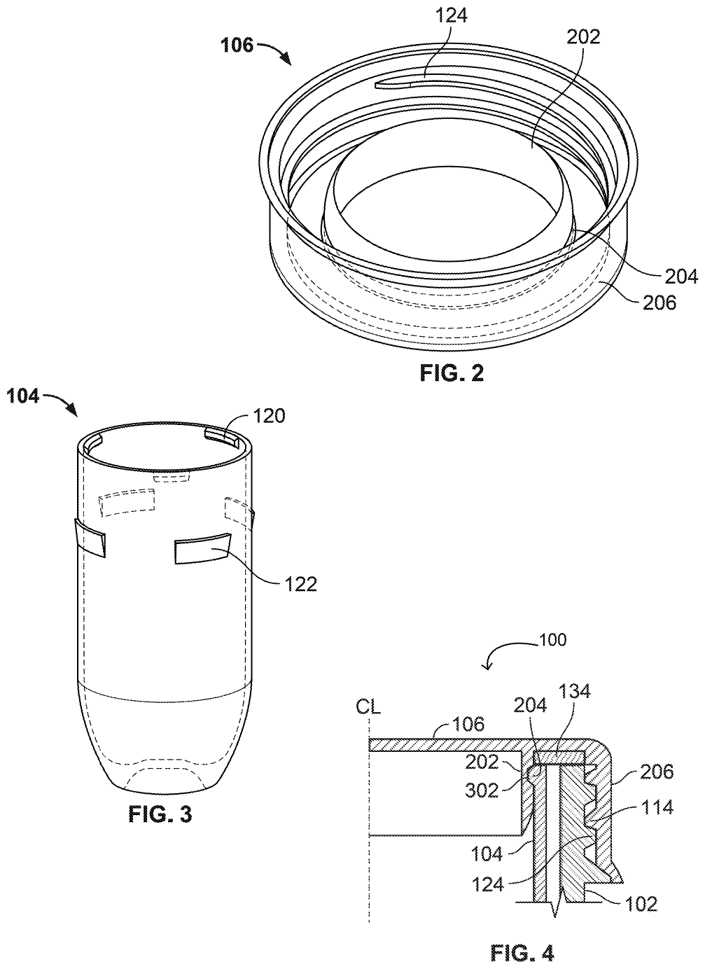

Referring now to FIG. 4, a partial cross-sectional view of container 100 is shown, including the interface of the first vessel 102, the second vessel 104, the cap 106, and the seal 134. In an example embodiment, a portion of the first vessel 102, second vessel 104, and seal 134 are located in the channel 132 defined between the first and second annular protrusions 202, 206 of the cap 106. The second annular protrusion 206 at least partially surrounds the portion of the first vessel 102 and the portion of the second vessel 104 that are within the channel 132. The cap 16 may be engaged with the first vessel 102 (e.g. via threads 124 of the cap 106 and threads 114 of the first vessel 102) to facilitate a secure, releasable engagement between the cap 106 and the first vessel 102. The first annular protrusion 202 may extend into the second vessel 104 (e.g. into an opening defined by the second vessel 104). The cap 106 may be engaged with the second vessel 104 (e.g. via protrusions 120 of the second vessel and circumferential recess 204 defined along at least a portion of the circumference of annular protrusion 202. In some embodiments, the first and second vessels 102, 104 may this be at least partially secured to the cap 106 by an interference fit.

Engagement between the cap 106, first vessel 102, and/or second vessel 104 may at least partially deform the seal 134 (e.g. in some optional embodiments, the seal 134 may be plastically deformed). The deformation of the seal 134 may facilitate consistent and reliable sealing engagement between the seal 134 and vessels 102, 104.

In some embodiments, the materials of one or more components of container 100 may be selected to impart characteristics that promote manufacturing, sealing, operation, etc. of container 100, and/or an enhanced user experience. In an example embodiment, the components do not have the same material characteristics. For example, in some embodiments, the seal 134 may be made from a material that is relatively softer and/or more resilient than a material of the cap 106, the first vessel 102, and/or the second vessel 104, such as a relatively softer and/or more resilient low density polyethylene. The softer and/or more resilient material may allow the seal 134 to deform and/or generate a restoring force that promotes a reliable and consistent seal to close first and second vessels 102, 104.

In some exemplary embodiments, first vessel 102 is made of a first material and second vessel 104 is made of a second material that is different than the first material. For example, the second material may be relatively harder, stiffer, and/or have an increased modulus as compared to the first material. Such relative material properties may facilitate assembly of second vessel 104 within first vessel 102, for example, such that the softer material of the first vessel 102 may allow for elastic deformation of the first vessel 102 that allows for the insertion of the second vessel 104 into the first vessel 102. In other exemplary embodiments, the first material may be relatively harder, stiffer, and/or have an increased modulus as compared to the second material. Such relative material properties may facilitate assembly of second vessel 104 within first vessel 102, for example, such that the softer material of the second vessel 104 may allow for elastic deformation of the second vessel 104 when inserted into the first vessel 102.

Alternatively or additionally, the cap 106 may be made of a third material that may be relatively softer, more flexible, and/or have a reduced modulus as compared to the first and/or second material. In other exemplary embodiments, the third material may be the same, or have similar material characteristics, as compared to the first or second materials.

In some embodiments, the visual characteristics of first vessel 102, second vessel 104, and/or cap 106 may be selected to enhance the user experience. For example, the container 100 may be configured to promote user perception of dropping a shot glass into a beverage container. The first vessel 102 may be made from a material that is sufficiently transparent to allow the release and movement of second vessel 104 within the first vessel 102 to be seen. In an example embodiment, both the first vessel 102 and the second vessel 104 are transparent and have a similar color. In other embodiments, the first vessel 102 may be transparent and the second vessel 104 may be substantially opaque. Alternatively or additionally, the first vessel 102 may have a first color and the second vessel 104 may have a second color that is different than the second vessel. Accordingly, in some embodiments, the visual perception of the first and second vessels 102, 104 may be enhanced.

The second vessel 104 may be configured to sink or otherwise be submerged when released into the first vessel 102. In an example embodiment, second vessel 104 may be made of a glass, polymer, metal, or other material having a density greater than water or other liquid contained with the first vessel 102. Alternatively or additionally, the second vessel 104 may be shaped to deter a buoyancy effect and/or to rotate after being released within the first vessel 102 such that the contents of second vessel 104 are brought into fluid engagement with the contents of first vessel 102.

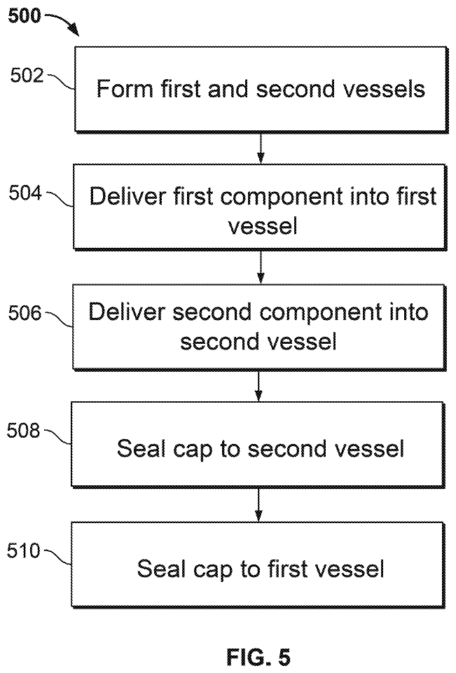

Referring now to FIG. 5, a flow diagram of an example method 500 of making a storage and mixing container is shown. In an exemplary embodiment, method 500 includes operation 502 of forming first vessel that defines a first cavity configured to hold a first component and a second vessel that defines a second cavity configured to hold a second component. The first and second vessels may be independently formed (e.g. independently molded) as separate components. In some optional embodiments, operation 502 may include forming a cap and/or a seal.

Method 500 may include operation 504 of delivering a first component into the first vessel and operation 506 of delivering a second component into the second vessel. In an example embodiment, the first component may be a first liquid, such as a first liquid beverage component, and the second component may be a second liquid, such as a second liquid beverage component. The first and second components may thus be different liquid beverage components.

In an example embodiment, method 500 includes operation 508 of sealing a cap to the second vessel. For example, second vessel may have an opening that is closed by engagement with the cap. The cap and/or second vessel may include a seal that promotes sealing engagement between the cap and the second vessel.

Example method 500 may further include operation 510 of sealing the cap to the first vessel. In an example embodiment, operation 510 is performed after operation 508, by inserting the cap and second vessel assembly at least partially within the first vessel. Operation 508 may result in sealing engagement between the cap and the first and second vessels, respectively, while the second vessel is accommodated within the first vessel suspended form the cap.

In an exemplary embodiment, method 500 provides first and second components within first and second vessels that are sealed out of fluid communication with one another and the external environment. The method 500 thus may provide an efficient and effective technique for manufacturing and assembling a container that allows long term storage of components, such as beverage components, that may be subsequently mixed at a time of consumption.

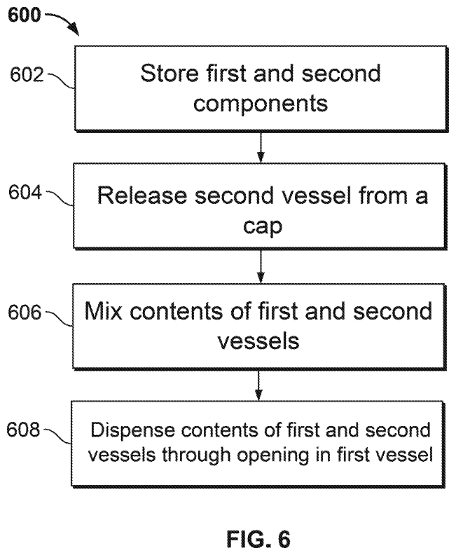

Referring now to FIG. 6, a flow diagram of an example method is shown of mixing first and second beverage components. In an exemplary embodiment, method 600 includes optional operation 602 of independently storing first and second components in a container. For example, a first component may be stored in a first vessel and a second component may be stored in a second vessel of a container. The components may be stored out of fluid communication with one another and/or the external environment, such as by sealing engagement with a single, common seal.

In an example embodiment, method 600 includes operation 604 of releasing a second vessel from engagement with a cap. In an example embodiment, operation 604 may include separating a cap from one or more other components of a container, such as by twisting or unscrewing the cap. Relative movement of the cap may cause the second vessel to be released from the cap and fall within a cavity of the first vessel (e.g. due to gravity). In an example embodiment, operation 604 does not include breaking any component connecting second vessel and the cap (e.g. no frangible seal, connecting web, or other breakable component connects the second vessel and the cap before the second vessel and the cap are separated).

In an example embodiment, method 600 includes operation 606 of mixing the contents of the first vessel and the second vessel. Operation 604 of releasing the second vessel may allow fluid communication between the first and second vessel. In an example embodiment, operation 606 may occur after operation 604 without any additional manual intervention or action.

Method 600 may optionally include operation 608 of dispensing the contents of the first and second vessel through an opening in the first vessel. In an exemplary embodiment, the contents of the first and second vessels are beverage components, and the first and second beverage components (e.g. which are at least partially mixed) may be consumed through an opening in the first vessel while the second vessel remains accommodated within the first vessel.

In various exemplary embodiments, the devices systems and methods described herein can be used to store, mix, and/or deliver a variety of component types, such as beverage components, medications, cosmetic products, epoxy or resin products, chemical products, industrial products, etc.

While this disclosure contains many specific embodiment details, these should not be construed as limitations on the scope of what may be claimed, but rather as descriptions of features specific to particular embodiments. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A container, comprising:
a first vessel comprising:
a first cavity configured to contain a first fluid; and
a top region that defines a first outlet, the top region including an outer surface having engagement threads;
a second vessel configured to be retained within the first vessel by an interference along an outer surface of the second vessel, the second vessel comprising:
a second cavity configured to contain a second fluid out of fluid communication with the first fluid; and
a top region that defines a second outlet;
a threaded cap having an annular channel; and
a seal located in the annular channel of the cap, wherein in a first configuration the top region of the first vessel and the top region of the second vessel are each in sealing engagement with the seal, and in a second configuration the second vessel is completely separated from the cap, and wherein axial removal of the threaded cap causes the second vessel to be released from the first configuration to the second configuration.

2. The container of claim 1, wherein the threaded cap and the second vessel are separately formed components.

3. The container of claim 1, wherein in the first configuration the second vessel is suspended within the first vessel by an interference fit with the threaded cap.

4. The container of claim 1, wherein the second vessel is fully sealed by engagement with the seal within the cap.

5. The container of claim 1, wherein the cap comprises an annular protrusion, and when in the first configuration the annular protrusion is located at least partially within the first vessel and the second vessel.

6. The container of claim 5, wherein the cap further comprises a circumferential recess along an outer circumference of the annular protrusion, and wherein the second vessel comprises a plurality of protrusions along an inner surface of the second vessel, the plurality of protrusions configured to be received by the recess.

7. The container of claim 6, wherein the plurality of protrusions comprises three protrusions spaced along the inner surface of the second vessel.

8. The container of claim 1, wherein the seal is made of a first material and the cap is made of a second material, and the first material is softer than the second material.

9. The container of claim 1, wherein the cap is made of a first material and the first vessel is made of a second material, and the first material is softer than the second material.

10. The container of claim 1, wherein the first vessel is made of a first material and the second vessel is made of a second material, and the first material is softer than the second material.

11. The container of claim 1, wherein in the first configuration the first vessel contains a non-alcoholic liquid and the second vessel contains an alcoholic liquid.

12. A container comprising:
a first vessel comprising:
a first cavity, and
a top region that defines an opening and includes first threads along an outer surface of the first vessel; and
a cap comprising:
a first annular protrusion extending towards an interior of the first cavity when the cap is installed on the first vessel;
a second annular protrusion extending parallel with the first annular protrusion, the second annular protrusion having second threads along an inner surface of the second annular protrusion, the second threads configured to engage with the first threads; and
a second vessel configured to be accommodated within the first vessel, the second vessel comprising:
an attachment means configured to secure the second vessel to the cap, and
a retention means configured to retain the second vessel within the first vessel when the cap is removed from the first vessel; and
an annular seal located within the cap, the annular seal located between a first annular protrusion of the cap and a second annular protrusion of the cap, wherein in a first configuration, the first vessel and the second vessel are each in direct sealing engagement with the annular seal.

13. The container of claim 12, wherein the annular seal is made of a first material and the cap is made of a second material, and the first material is softer than the second material.

14. The container of claim 12, wherein the cap is made of a first material and the first vessel is made of a second material, and the first material is softer than the second material.

15. The container of claim 12, wherein the first vessel is made of a first material and the second vessel is made of a second material, and the first material is softer than the second material.

16. The container of claim 12, wherein the cap further comprises a circumferential recess along an outer circumference of the first annular protrusion, and wherein the second vessel comprises a plurality of protrusions along an inner surface of the second vessel, the plurality of protrusions configured to be received by the circumferential recess.

17. The container of claim 16, wherein the plurality of protrusions comprises three protrusions equally spaced along the inner surface.

18. The container of claim 12, wherein in the first configuration the first vessel contains a non-alcoholic liquid and the second vessel contains an alcoholic liquid.

19. A method of storing and mixing beverage components comprising:
storing a first beverage component within a first vessel, the first vessel sealingly engaged with a seal of a cap; and
storing a second beverage component in a second vessel out of fluid communication with the first vessel, wherein the second vessel is located within the first vessel and sealingly engaged with the seal of the cap.

20. The method of claim 19, further comprising:
releasing the second vessel into the first vessel when the cap is removed from the first vessel.
